(19) United States
(12) Patent Application Publication
(10) Pub. No.: US 2011/0184934 A1
(43) Pub. Date: Jul. 28, 2011

(54) WAVELET COMPRESSION WITH BOOTSTRAP SAMPLING

(76) Inventors: Choudur LAKSHMINARAYAN, Austin, TX (US); Joe HILL, Austin, TX (US); Ram SWAMINATHAN, Cupertino, CA (US)

(21) Appl. No.: 12/695,963

(22) Filed: Jan. 28, 2010

(51) Int. Cl. G06F 17/30; G06F 17/14

(52) U.S. Cl. 707/718; 382/248; 708/400; 707/E17.017; 707/E17.019; 707/E17.044

(57) ABSTRACT

A method for compressing an initial dataset may be implemented on a data processing system. The method may include generating a group of bootstrap samples of wavelet coefficients from the initial dataset using a wavelet basis function. An average quantile of the group of bootstrap samples of wavelet coefficients may be determined. The group of wavelet coefficients may be compressed by deleting initial wavelet coefficients having magnitudes less than the coefficient cutoff value equal to the average quantile. The compressed group of wavelet coefficients and the wavelet basis function may be used to approximate the initial dataset.

### BACKGROUND

A database is a collection of information. A relational database is a database that is perceived by its users as a collection of tables. Each table arranges items and attributes of the items in rows and columns respectively. Each table row corresponds to an item (also referred to as a record or tuple), and each table column corresponds to an attribute of the item (referred to as a field, an attribute type, or field type). To retrieve information from a database, the user of a database system constructs a query. A query contains one or more operations that specify information to retrieve from the database. The system scans tables in the database to execute the query.

A database system can optimize a query by arranging the order of query operations. In databases, summaries or synopses are used because it is unreasonable to store or scan the entire table during optimization. Query optimizers may use summaries to get quick-albeit approximate-cardinality estimates of certain columns to generate query execution plans based on a cost model. Data summaries that are efficient to produce and that adequately represent the initial data provide for effective optimization.

### BRIEF DESCRIPTION OF THE DRAWINGS

Features and advantages of examples of systems, methods and devices will become apparent by reference to the following detailed description and drawings.

FIG. 1 is a block diagram depicting an example of a data processing system in accordance with an embodiment of the invention.

FIG. 2 is a flow chart of an example of a method of compressing data in accordance with an embodiment of the invention.

FIG. 3 is a block diagram of an exemplary database system that compresses data in accordance with an embodiment of the invention.

FIG. 4 is a simplified block diagram of an exemplary data processing system that compresses data in accordance with an embodiment of the invention.

FIG. 5 is a graph illustrating the relationship between a number of wavelet coefficients and their cumulative energy in accordance with an embodiment of the invention.

FIG. 6 is a block diagram of an exemplary wavelet-transform-based compression module with bootstrap sampling that may be used with the system of FIG. 1, FIG. 3, or FIG. 4 in accordance with embodiments of the invention.

FIG. 7 is a flowchart illustrating an exemplary data compression-decompression operation on the compression module of FIG. 6 in accordance with an embodiment of the invention.

FIG. 8 is a table showing the results of compressing data in accordance with exemplary embodiments of the invention.

### DETAILED DESCRIPTION

Many applications, including digital image processing and database searching, for example, require access to large quantities of data. Because of the large data quantities involved, these applications may employ some form of data compression so as to reduce the necessary storage and bandwidth requirements for associated hardware, and allow data extraction for editing, processing, and targeting of particular devices and operations. Many compression/decompression mechanisms are “lossy,” meaning the decompressed data are not exactly the same as the initial data before compression. However, lossy compression/decompression mechanisms are able to achieve a much greater compression ratio than conventional lossless methods. Furthermore, the loss of data may have little affect on the specific application.

Compression mechanisms may use an encoding technique known as a wavelet transformation. Wavelets are mathematical functions that parse data into different frequency components and then compare each component with a resolution matched to its scale. Wavelets are better suited than traditional Fourier (e.g., discrete cosine transform or DCT) methods in analyzing physical situations where the signal contains discontinuities and sharp spikes, as often is the case in image processing. Wavelets also are useful when analyzing large quantities of structured and unstructured data, as might exist in a large database.

The basis functions of the wavelet transforms are small waves or wavelets developed to match signal discontinuities. The wavelet basis function of a wavelet has finite support of a specific width. Wider wavelets examine larger regions of the signal and resolve low frequency details accurately, while narrower wavelets examine a small region of the signal and resolve spatial details accurately. Wavelet-based compression has the potential for satisfactory compression ratios while being computationally efficient.

The wavelet transform uses short waves that start and stop with different time and spatial resolutions, while the DCT or the fast Fourier transform (FFT) have a set of fixed and well defined basis functions over an infinite support. For a specified transform, some wavelet mechanisms do not use a specific formula for the basis function but rather a set of mathematical requirements such as a smoothness condition and vanishing moment condition. Thus, a first step in wavelet analysis may be to determine and designate wavelet bases to use and that determination may depend on the specific application. Designing and finding such wavelet bases to be designated for use is not a trivial task because it is mathematically involved. Fortunately, numerous researchers have designed a number of specific wavelet basis functions, with Daubechies wavelets and Haas wavelets being two examples.

Database search applications may use data compression mechanisms to optimize search results, contend with limited bandwidth, and reduce the need for data storage, which in turn may reduce costs associated with the database searches. For example, with an ever increasing need for business intelligence to support critical decision-making, and for compliance with ever-increasing legal regimes as exemplified by the Sarbanes-Oxley legislation, it may be useful for companies to store and access (query) large amounts of structured and unstructured data. Data compression techniques may be used to improve the efficiency of information management with regards to storage, transmission, and analysis. Real-time business intelligence may put a heavy burden on the query optimization in database systems.

The algorithms used to implement compression in database search applications may be implemented in both software and hardware.

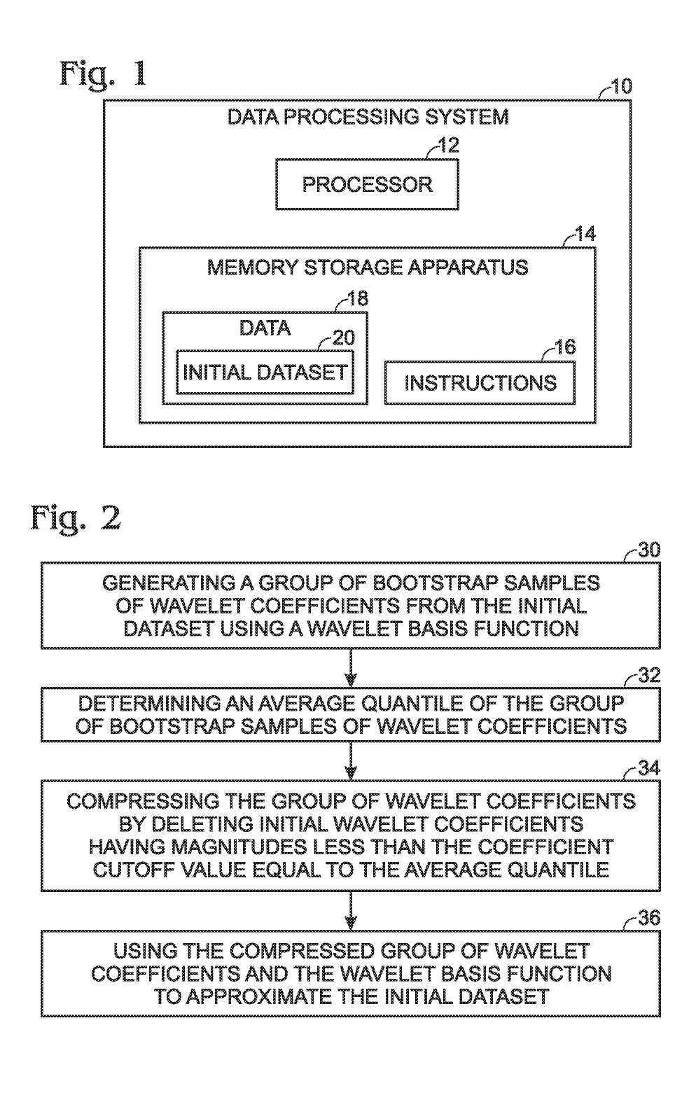

FIG. 1 illustrates an example of a data processing system 10 that may be used to provide data compression. Data processing system 10 may include one or more computer systems, including any intercommunication devices such a local and wide area networks. Accordingly, the data processing system may include hardware, software, and firmware. For example, hardware may include a central processing unit (CPU) or processor 12, a memory storage apparatus 14, and input/output connections, chipsets, and other hardware components, not shown. The memory storage apparatus may be any suitable type of storage device or devices resident in or in association with one or more of the computer systems, and may include non-volatile memory and volatile memory. The non-volatile memory may include executable software instructions 16 for execution by the processor, including instructions for operating system and other applications, as well as storing data 18, such as an initial dataset 20.

Generally, data processing system 10 may provide for compression of initial dataset 20. An example of a method for compressing the initial dataset is illustrated in the flow chart of FIG. 2. Such a method may be implemented on data processing system 10. The method may include in a step 30 generating a group of bootstrap samples of wavelet coefficients from the initial dataset using a wavelet basis function. An average quantile of the group of bootstrap samples of wavelet coefficients may then be determined in a step 32. The group of wavelet coefficients may then be compressed in a step 34 by deleting wavelet coefficients having magnitudes less than a coefficient cutoff value equal to the average quantile. Further, in a step 36, the compressed group of wavelet coefficients and the wavelet basis function may be used to approximate the initial dataset.

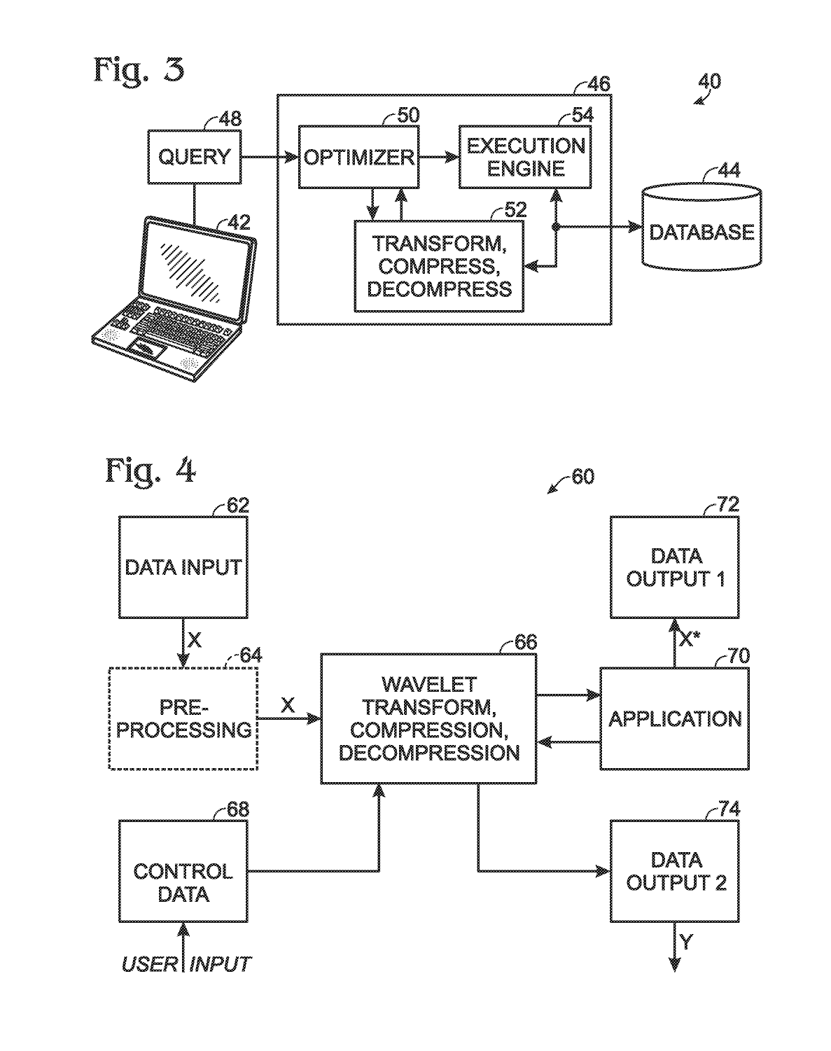

FIG. 3 is a simplified block diagram of an exemplary database system 40 that may use wavelet thresholding based on pre-specified accuracy using coefficient bootstrap sampling to achieve data compression and consequently facilitate efficient database searching. The database system 40 may include a computing platform 42, a database 44, and a database search system 46. The computing platform 42 may be a personal computer (PC) or work station, for example, which allows a human operator to set up or launch queries 48 of database 44. The database 44 may comprise a relational database including what may be considered columns and rows of data arranged in one or more tables.

Other structures are possible with the database system 40. For example, computing platform 42 may operate autonomously of any direct human intervention to make queries 48 of the database 44. In other words, a suitably programmed processor may execute routine or periodic queries, or may execute episodic queries based on the occurrence of pre-specified events. In either case of the computing platform 42, the end result is a query 48 that is presented to components of the database search system 46.

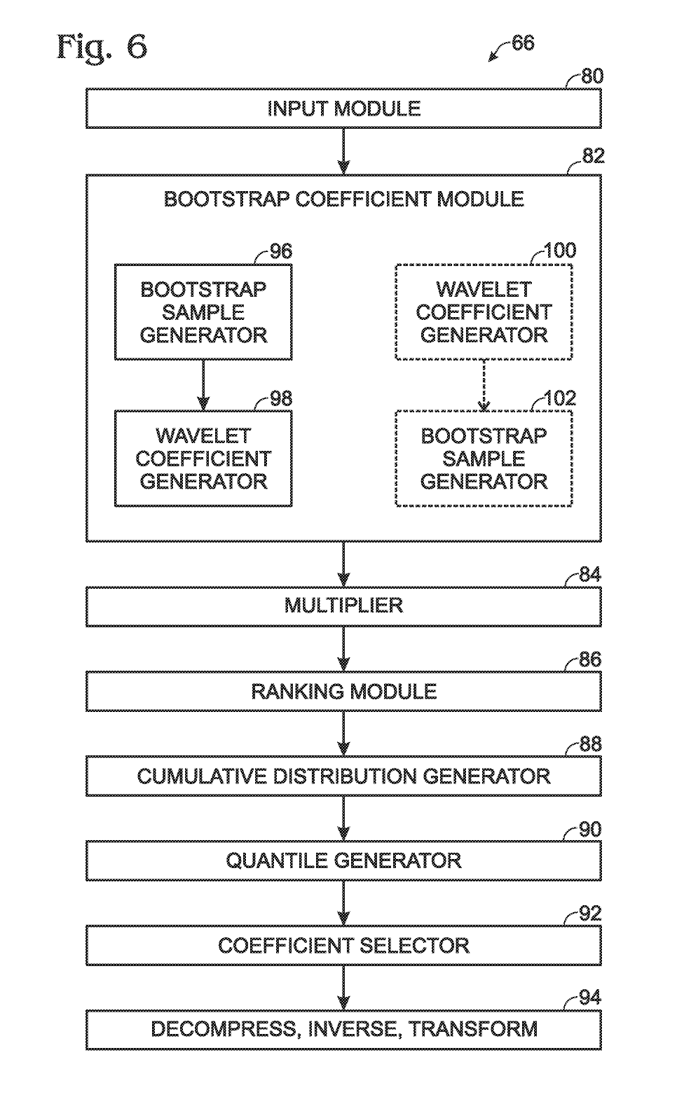

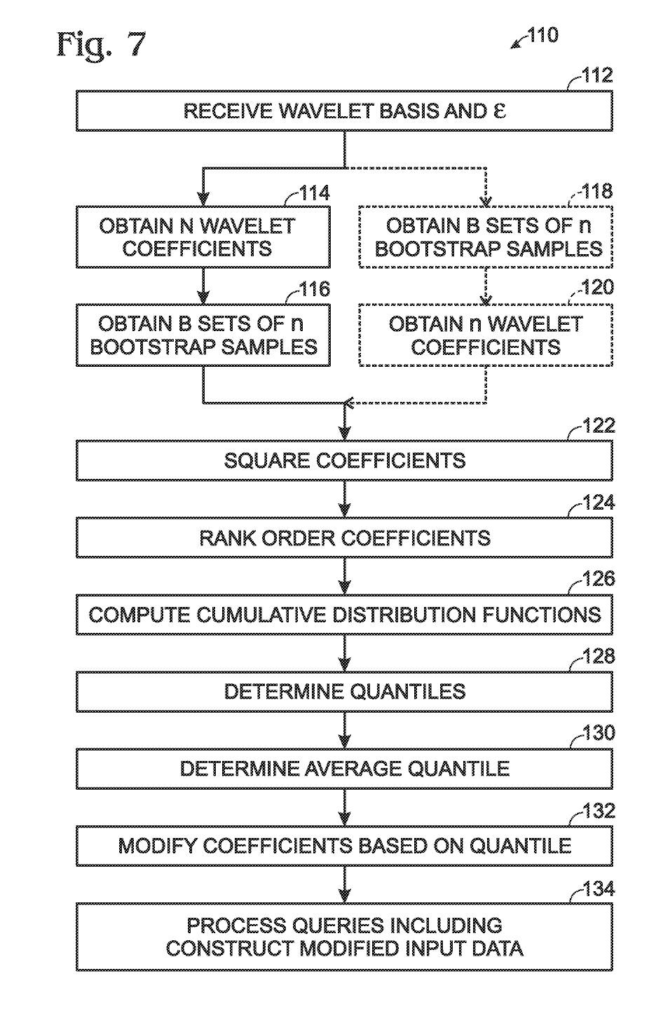

The database search system 46 may include a query optimizer 50, a compression module 52, and an execution engine 54. The compression module 52 is described in detail with reference to FIGS. 6 and 7. The query optimizer 50 may determine query plans that the execution engine 54 uses to fulfill the query 48. A query plan might designate the order of searching columns of data in the database 44, for example. One function of the query optimizer 50 may be to estimate approximate cardinalities of columns based on which query plan is generated. As will be discussed below, the compression module 52 may be used to increase the query optimizer's performance. Inaccurate estimation can have adverse consequences in down stream query execution.

The compression module 52 may use wavelet-based compression techniques combined with selectable thresholding (i.e., thresholding based on a pre-determined level of accuracy) to enable the query optimizer 50 to construct an efficient query plan given specific inputs (the query 48) from the computing platform 42. The optimizer 50 may sample data in various columns or tables of the database 44 and then use the compression module 52 to perform a wavelet transform and threshold operation to determine an efficient query plan.

FIG. 4 is a simplified block diagram of an exemplary data processing system 60 that may use wavelet thresholding based on pre-specified accuracy. The system 60 may be implemented in many diverse applications, and is particularly suited to data-intensive processing, particularly searching large databases. Another example of such an application is the digital image processing occurring in a digital camera, including cameras installed on cellular telephones. Considering the large amount of memory required to store or transmit a single digital image in uncompressed digital form, it would be desirable to compress the digital image data before storage or transmission in such a way that the compressed digital data could later be decompressed to recover the initial image data for viewing. Other examples of applications that would benefit from wavelet thresholding based on pre-specified accuracy include image processing and transmission applications, including Web-based image transfer, medical imaging applications, as well as database search engines.

In FIG. 4, the processing system 60 may include data input module 62, a pre-processing module 64, a wavelet transformation, compression, and decompression module 66, control data input module 68, application 70, and data output modules 72 and 74. The functions and operations of the wavelet transformation, compression, and decompression module 66 are described in more detail with respect to FIG. 6. Other configurations of processing system 60 may be used. For example, the compression and decompression actions may be completed in a module separate from the transformation and compression actions.

The wavelet transform may use a wavelet prototype function, often called a mother wavelet, and denoted herein by Ψ. To complete the specification of a wavelet, another term, called a father wavelet, or scaling function, and denoted herein by φ, may be used. The mother wavelet may be obtained by scaling and translating the father wavelet. Temporal analysis may be performed with a contracted, high-frequency version of the mother wavelet, while frequency analysis may be performed using a dilated, low-frequency version of the same mother wavelet. Because the initial signal or function can be represented in terms of a wavelet expansion, using coefficients in a linear combination of the wavelet function, data operations can be performed using just the corresponding wavelet coefficients. Thus, a wavelet expansion of a function may include a set of basis elements that are obtained through a series of dilation and translation operations. The resulting vectors may be orthogonal to one another over a compact support.

Dilating and translating the mother wavelet may result in a sequence of nested vector subspaces leading to multi-resolution analysis (MRA). Multi-resolution analysis may involve decomposing data at various levels known as resolutions. The data at a certain resolution are composed by combining its “cousins” at a higher level of resolution. In other words, the wavelet coefficients may be obtained at various levels, approximating the data with greater and greater precision as resolution increases. Conversely as the resolution decreases, the result may be smoothed versions of the signal, or data.

Compression may begin after the selection of a suitable wavelet basis by a database architect in advance of processing any queries. The applicable wavelet bases may be selected from a list of available wavelet bases. The wavelet basis may be used to model the attribute distribution f(x), which can be described by the equation

$$f ( x ) = αφ ( x ) + {\sum }_{j = 0}^{m} {\sum }_{k = 0}^{{2}^{j} - 1} {β}_{jk} {ψ}_{jk} ( x ) ,$$

where the set {α,βⱼₖ} represents the set of wavelet coefficients. Applying the wavelet transform to a dataset X=[x₁, x₂, x₃, . . . , x_{N}] of size N, the wavelet coefficients can be generically represented by the set {cᵢ}ᵢ₌₁^{N}, letting m=log₂(N). These coefficients may measure the degree of association between the attribute values and the wavelet basis. In many applications, the majority of wavelet coefficients will be negligible in magnitude and thus do not contribute to describing the data subjected to the wavelet transform. Therefore, these non-value-added coefficients can be discarded. The resulting set {cᵢ}ᵢ₌₁^{k}, k<<N may represent the compressed set of wavelet coefficients. The process of discarding small magnitude coefficients to achieve the compression is known as thresholding.

Hard thresholding (HRT) may be applied to the dataset X=[x₁, x₂, x₃, . . . , x_{N}] of size N, and may select from the dataset X the “k” coefficients that are largest in magnitude. The choice of the k coefficients may be in relation to a threshold “λ” computed based on the standard deviation (σ) of the detail coefficients (the βs) at the highest resolution (j=1). The threshold λ may be an estimate of the magnitude of noise. An estimate of σ is given by

$$\hat{σ} = \frac{{\sum }_{i = 1}^{N 1} \vert {c}_{i} - med ( {c}_{i} ) \vert}{0.6745} ,$$

where med(cᵢ) is the median of the coefficients and N1 denotes the number of coefficients at the finest level. The threshold may be given by λ=\hat{δ}\sqrt{2 log(N)/N}, as described by Donoho and Johnstone in Ideal Spatial Adaptation by Wavelet Shrinkage, Stanford University, 1992. The coefficients (cᵢ) in absolute value that exceed λ may be retained and those that are less than λ may be set to zero. In other words, the hard thresholding may return coefficients cᵢχ, where χ is the indicator function for |cᵢ|>λ.

Soft thresholding (SFT) may be based on the idea of “wavelet shrinkage.” Similar to HRT, SFT sets to zero all those coefficients whose absolute values are smaller than λ, and then shrinks the coefficients that exceed λ in absolute value towards zero. The surviving coefficients may be given by c*ᵢ=sgn(cᵢ)(|cᵢ|−λ), where sgn( ) is the standard signum function. The term cᵢ* may be computed if (|cᵢ|−λ) is positive; otherwise its value may be set to zero. When \hat{δ} is the standard deviation of the noise coefficients, (|cᵢ|−λ) are the de-noised values of the remaining coefficients.

Both hard and soft thresholding may be conservative and therefore retain coefficients that do not contribute significantly to the energy in the data. This is less desirable for compression as more non-zero coefficients have to be stored for decompression later. Both hard and soft thresholding techniques may discard coefficients based on the threshold λ and produce near zero error in reconstruction. However, the threshold λ is a fixed value. Flexibility is desirable in some applications because space may be a more important factor than perfect reconstruction.

This energy-based thresholding (EBT) approach may use the cumulative energy (squares of coefficients) to capture information in the data. The graphing parameters may be given by the set

$$\{ k , {\sum }_{i = 1}^{k} {c}_{( i )}^{2} \} ,$$

where “i” indexes the ordered wavelet coefficients c₍₁₎≧ . . . ≧c₍ₖ₎, and

$${\sum }_{i = 1}^{k} {c}_{( i )}^{2}$$

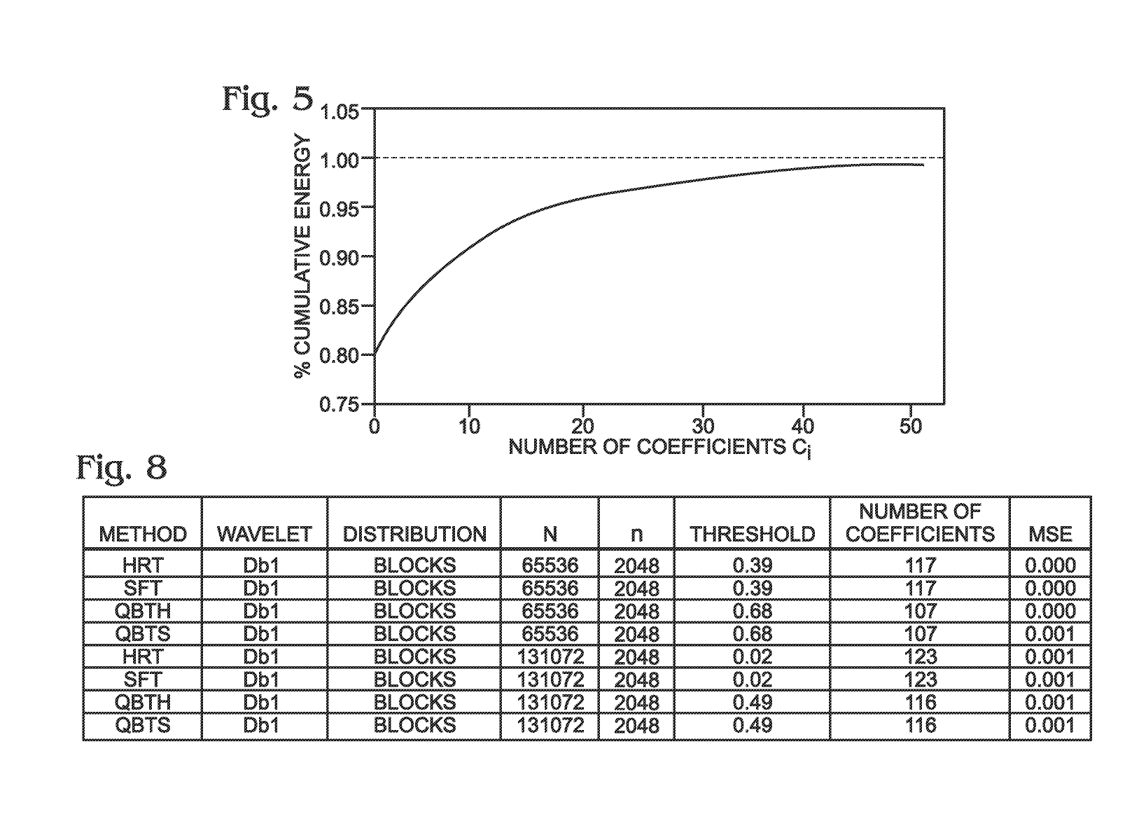

is the cumulative energy up to the coefficient c₍ₖ₎. A representative plot is given in FIG. 5. As can be seen in this example, for a data-vector of 64 observations, approximately 25 coefficients contain 95 percent of the information.

Turning to FIG. 6, operation of an example of the compression module 66 will now be explained. The compression module 66 may include an input module 80, a bootstrap coefficient generator 82, a multiplier 84, a ranking module 86, a cumulative distribution generator 88, a quantile generator 90, a coefficient selector 92, and a decompression module 94. In an embodiment, the input module 80 may be used to receive a desired wavelet basis function (e.g., Haar or Daubechies) from the computing platform 42 or other source. In another embodiment, the input module 80 may store pre-determined basis functions, and may either select an appropriate basis function, or receive a selection from one of the stored bases. The stored basis functions may be determined in advance by testing various signal functions and applying the basis functions to data in the database 44. Basis functions that perform well then may be stored.

The input module 80 also may receive a value of desired accuracy for the query 48, expressed as a percentage value ε. This percentage value ε, or accuracy, may be used to determine the degree of compression to apply to the dataset X, in a manner analogous to picking a point on the graph of FIG. 5, as described above. The coefficient generator 82 may generate a series of sets of wavelet coefficients using bootstrap sampling.

In one example, coefficient generator 82 may include a bootstrap sample generator 96 and a wavelet coefficient generator 98. In this example, let X=[χ₁, χ₂, . . . , χ_{N}] be the initial dataset or signal. Bootstrap sample generator 96 may obtain a series of B bootstrap samples of the signal, each of size n:

$${M}_{1} = [ \begin{matrix}{x}_{11} & {x}_{12} & … & {x}_{1 n} \\ {x}_{21} & {x}_{22} & … & {x}_{2 n} \\ ⋮ & ⋮ & ⋮ & ⋮ \\ {x}_{B 1} & {x}_{B 2} & … & {x}_{Bn}\end{matrix} ] ,$$

where n<N.

From the bootstrap samples M₁ of the signal, wavelet coefficient generator 98 may apply the wavelet transform to produce a series of wavelet coefficients:

$${M}_{2} = [ \begin{matrix}{c}_{11} & {c}_{12} & … & {c}_{1 n} \\ {c}_{21} & {c}_{22} & … & {c}_{2 n} \\ ⋮ & ⋮ & ⋮ & ⋮ \\ {c}_{B 1} & {c}_{B 2} & … & {c}_{Bn}\end{matrix} ] .$$

In another example, coefficient generator 82 may include a wavelet coefficient generator 100 and a bootstrap sample generator 102. Wavelet coefficient generator 100 may apply the wavelet transform to initial dataset or signal X to obtain the coefficients: C=[C₁, C₂, . . . C_{N}]. From the set of coefficients set C, bootstrap sample generator 102 may obtain B bootstrap samples each of size n:

$${M}_{3} = [ \begin{matrix}{c}_{11} & {c}_{12} & … & {c}_{1 n} \\ {c}_{21} & {c}_{22} & … & {c}_{2 n} \\ ⋮ & ⋮ & ⋮ & ⋮ \\ {c}_{B 1} & {c}_{B 2} & … & {c}_{Bn}\end{matrix} ] .$$

Following generation of the set of M₂ or M₂ by bootstrap coefficient generator 82, multiplier 84 may square each coefficient, cᵢⱼ². Ranking module 86 may order them in ascending order of magnitude given by: c₍ᵢ₁₎², c₍ᵢ₂₎², . . . , c₍ᵢₙ₎² for each row i. As explained above, these may represent the energies in the sampled signal.

For each row of coefficients {c₍ᵢⱼ₎²}ⱼ₌₁ⁿ, i=1, 2, . . . , B, cumulative distribution generator 88 may compute an empirical cumulative distribution given by:

$$\hat{{F}_{i} ( c )} = \frac{1}{n} {\sum }_{j = 1}^{n} I \{ {c}_{ij}^{2} \leq c \} , i = 1 , 2 , … , B$$

where c generically denotes a wavelet coefficient.

From the cumulative distribution, quantile generator may determine a quartile for each row. For example, the selected accuracy c may correspond to a quantile value of 10%, the 10^{th} quantile [(Q_{(0.10)}ⁱ)] may be determined. The 10th quantile, as an example, may identify the coefficients that contribute less than or equal to 10% of the energy. The 10% is chosen as an illustration. The user can select the appropriate quantile based on prior knowledge or data behavior. Repeating the determination of quantile for each bootstrap sample, i=1, 2, . . . , B, a set of quantiles, Q_{(0.10)}¹, Q_{(0.10)}², . . . , Q_{(0.10)}^{B} may be obtained.

Coefficient selector 92 may then compute an average quantile:

$$\overline{Q} = \frac{1}{n} {\sum }_{i = 1}^{B} {Q}_{( 0.10 )}^{i} .$$

The average quantile, Q̅ may be used as a threshold to delete low energy coefficients from the set C of wavelet coefficients obtained from the initial signal X. This step may correspond to applying Hard thresholding using the bootstrapped quantile average obtaining the vector (c′)_{1×k}, k<<N. Soft thresholding may be effected by modifying remaining coefficients by shrinking them towards zero by subtracting Q̅, obtaining: C*=[c*₁, c*₂, . . . , c*ₖ], k<<N where c*₁=|cᵢ|− Q̅. This process may correspond to applying Soft thresholding using the bootstrapped quantile average.

Finally, initial signal X may be reconstructed by decompression module 94 by applying an inverse transform to the coefficient subset c′ (Hard) or c* (Soft) to obtain an approximate vector X*.

A summary of the foregoing process is illustrated as a method 110 in FIG. 7. In a step 112 the wavelet basis and an accuracy level ε corresponding to a quantile level may be received. In one example, N wavelet coefficients may then be obtained of the initial dataset (signal) in a step 114 and B sets of n bootstrap samples of the coefficients may be obtained in step 116. In another embodiment, B sets of n bootstrap samples of the initial dataset may be obtained in a step 118, and n wavelet coefficients may be obtained in a step 120 for each set of bootstrap samples.

The coefficients in the B sets of wavelet coefficients may be squared in a step 122 and the B sets of squared coefficients may be ordered in a step 124. The cumulative distribution function for each set of squared coefficients may then be obtained in a step 126. The quantile of each set of squared coefficients may then be determined in a step 128, with the quantile corresponding to the received accuracy level. An average quantile may then be determined in a step 130. In a step 132, the average quantile may be used as a threshold to delete low-energy coefficients from a set of wavelet coefficients obtained from the initial dataset. Hard or Soft types of thresholding may be used. A representation of the initial dataset may be obtained in a step 134 by reconstructing the dataset using the compressed wavelet coefficients when queries are processed.

The quality of the compression procedure may be determined by computing a mean square error (MSE)/distortion metric denoted by D and given by:

$$D = \frac{1}{N} {( X - {X}^{*} )}^{T} ( X - {X}^{*} ) ,$$

where the symbol T denotes the transpose operation. FIG. 8 is a table that compares the traditional Hard (HRT) and Soft (SFT) thresholding methods with quantile-based hard thresholding (QBTH) and quantile-based soft thresholding (QBTS). The columns are method, wavelet decomposition used, with Db1 indicating the Haar wavelet was used in these examples, distribution characteristic was a signal in the form of square waves or blocks, N is the initial signal size, n is the size of the bootstrap samples, Threshold is the threshold value, Number of coefficients is the number of surviving coefficients after thresholding and MSE is the mean-squared error distortion metric (D). It is seen that the mean squared error is insignificant for all of these thresholding techniques, with somewhat fewer coefficients being used for the quantile-based thresholding, indicating improved levels of compression.

In summary, quantile-based wavelet compression provides a reliable framework for accurately characterizing, compressing, and reconstructing the initial data vector X.

Beside using the bootstrap compression process for optimizing queries on a database, the data processing systems described may be used for datasets or signals occurring in other applications. For example, it may be used in a digital camera for in-camera image processing and storage, and for subsequent image transmission, if desired. As applied to a digital camera, the data input module 62 may provide an input data file X, and may include an analog signal capture mechanism and an analog-to-digital converter. A preprocessing module 64 may convert a digitized RGB signal into another format, such as Y, Cb, Cr (luminance and color difference signals). Wavelet transformation, compression, and decompression module 66 may apply a wavelet transform basis function to the Y, Cb, Cr data to produce a set of transform coefficients, and discard certain of the coefficients, thereby achieving a measure of compression. The retained coefficients may then be used to reconstruct an output data file X* (e.g., a thumbnail image), as well as a data file Y which may be an interpolated version of the output data file X*, which may be used to produce a color image that is viewable by a human user. Control data module 68 may be used to select the degree of compression used by the module 66. The application 70 may then simply be an in-camera memory that stores compressed images (e.g., the data file X*). The data output module 72 may be used to display the thumbnail image (data file X*) on, for example, an in-camera LCD display. Data output module 74 may be used to transmit the data file Y, such as when downloading file Y to a computer.

We claim:

1. A method for compressing an initial dataset, implemented on a data processing system, comprising the steps of:
transforming the initial dataset into a group of initial wavelet coefficients using a wavelet basis function;
generating a group of bootstrap samples of wavelet coefficients from the initial dataset using the wavelet basis function;
determining an average quantile of the group of bootstrap samples of wavelet coefficients;
identifying a compressed group of wavelet coefficients by deleting initial wavelet coefficients having magnitudes less than a coefficient cutoff value equal to the average quantile; and
using the compressed group of wavelet coefficients and the wavelet basis function to approximate the initial dataset.

2. The method of claim 1, wherein generating a group of bootstrap samples of wavelet coefficients includes bootstrap sampling the group of initial wavelet coefficients.

3. The method of claim 1, wherein generating a group of bootstrap samples of wavelet coefficients includes bootstrap sampling the initial dataset and transforming each of the bootstrap samples from the initial dataset using the wavelet basis function to form sampled sets of wavelet coefficients.

4. The method of claim 1, wherein determining an average quantile includes, for each set of coefficients,
squaring the coefficients to produced squared coefficients,
ordering the squared coefficients by size,
computing the cumulative distribution function of the ordered squared coefficients, and
determining an individual quantile corresponding to the values of coefficients included in a given quantile.

5. The method of claim 4, wherein determining an average quantile includes determining an average quantile from the individual quantiles.

6. The method of claim 1, further comprising performing an operation on the initial dataset using the compressed group of initial coefficients.

7. The method of claim 6, wherein performing an operation includes generating a query plan for executing a query of a database.

8. A data processing system for compressing an initial dataset comprising:
memory storage apparatus for storing the initial dataset and processor readable instructions; and
a processor for executing the processor-readable instructions for transforming the initial dataset into a group of initial wavelet coefficients using a wavelet basis function;
generating a group of bootstrap samples of wavelet coefficients from the initial dataset using the wavelet basis function;
determining an average quantile of the group of bootstrap samples of wavelet coefficients;
identifying a compressed group of wavelet coefficients by deleting initial wavelet coefficients having magnitudes less than a coefficient cutoff value equal to the average quantile; and
using the compressed group of wavelet coefficients and the wavelet basis function to approximate the initial dataset.

9. The data processing system of claim 8, wherein the processor is further for executing the processor-readable instructions for bootstrap sampling the group of initial wavelet coefficients.

10. The data processing system of claim 8, wherein the processor is further for executing the processor-readable instructions for bootstrap sampling the initial dataset and transforming each of the bootstrap samples from the initial dataset using the wavelet basis function to form sampled sets of wavelet coefficients.

11. The data processing system of claim 8, wherein the processor is further for executing the processor-readable instructions, for each set of coefficients, for
squaring the coefficients to produced squared coefficients,
ordering the squared coefficients by size,
computing the cumulative distribution function of the ordered squared coefficients, and
determining an individual quantile corresponding to the values of coefficients included in a given quantile.

12. The data processing system of claim 11, wherein the processor is further for executing the processor-readable instructions for determining an average quantile from the individual quantiles.

13. The data processing system of claim 8, wherein the processor is further for executing the processor-readable instructions for performing an operation on the initial dataset using the compressed group of initial coefficients.

14. The data processing system of claim 13, wherein the processor is further for executing the processor-readable instructions for generating a query plan for executing a query of a database.

15. A computer-readable storage device readable by one or more computer systems and having embodied therein a program of computer-readable instructions that, when executed by the one or more computer systems, provide for:
transforming the initial dataset into a group of initial wavelet coefficients using a wavelet basis function;
generating a group of bootstrap samples of wavelet coefficients from the initial dataset using the wavelet basis function;
determining an average quantile of the group of bootstrap samples of wavelet coefficients;
identifying a compressed group of wavelet coefficients by deleting initial wavelet coefficients having magnitudes less than a coefficient cutoff value equal to the average quantile; and
using the compressed group of wavelet coefficients and the wavelet basis function to approximate the initial dataset.

16. The computer-readable storage device of claim 15, wherein the program further provides for bootstrap sampling the group of initial wavelet coefficients.

17. The computer-readable storage device of claim 15, wherein the program further provides for bootstrap sampling the initial dataset and transforming each of the bootstrap samples from the initial dataset using the wavelet basis function to form sampled sets of wavelet coefficients.

18. The computer-readable storage device of claim 15, wherein the program further provides for, for each set of coefficients,
squaring the coefficients to produced squared coefficients,
ordering the squared coefficients by size,
computing the cumulative distribution function of the ordered squared coefficients, and
determining an individual quantile corresponding to the values of coefficients included in a given quantile.

19. The computer-readable storage device of claim 18, wherein the program further provides for determining an average quantile from the individual quantiles.

20. The computer-readable storage device of claim 15, wherein the program further provides for performing an operation on the initial dataset using the compressed group of initial coefficients.
